(19) United States
(12) Patent Application Publication
(10) Pub. No.: US 2004/0178906 A1
(43) Pub. Date: Sep. 16, 2004

(54) Distance monitoring system using dual timers

(76) Inventors: Billy S. Vaughan, San Juan Capistrano, CA (US); Peter Knorre, San Juan Capistrano, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/388,040

(22) Filed: Mar. 12, 2003

(51) Int. Cl. G08B 1/08

(52) U.S. Cl. 340/539.21

(57) ABSTRACT

A monitoring system uses a portable master unit and at least one portable slave unit. The master unit provides an electrical circuit including an antenna, an RF signal amplifier, an RF signal tuner, a countdown timer, an attenuator, an adjustable delay timer, an AND gate and an audible alarm. Each of the slave units providing a slave circuit including a transmitter with transmitting antenna and an RF pulse generating circuit. The master unit is adjusted for receiving RF energy transmitted by a slave unit when the units are separated by a target distance or less. A time delay parameter is set using dual timers so that the slave may be positioned beyond the allowable distance parameter for a pre-selected duration before the alarm is triggered.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

1. Field of the Invention

This invention relates generally to wireless monitoring devices and more particularly to a personal monitor for monitoring the distance between a parent and child, master and pet or between a person and an article.

2. Description of Related Art

The following art defines the present state of this field:

Narcisse, U.S. Pat. No. 4,593,273 describes an out-of-range monitor and alarm system that may be used by a convalescent home or the like to alert an attendant in the home that a supervised person has walked beyond a predetermined prescribed distance. The system includes a base unit that transmits a signal at a frequency F1 to a receiver in a mobile unit carried by the supervised person. The receiver includes a threshold circuit that is adjustable to correspond to the prescribed distance and produces a threshold output signal whenever the F1 signal detected by the receiver drops below the threshold level. In response to the threshold output signal, a transmitter in the mobile unit produces an F2 output signal to a receiver in the base unit, which in turn sounds an alarm indicating that the mobile unit has lost adequate F1 signal strength, as determined by the threshold adjustment, by exceeding the range prescribed for the supervised person.

Traxler, U.S. Pat. No. 5,689,240 describes a system that transmits and receives signals comprising a master unit and a remote unit, wherein a separation distance between the master unit and remote unit is continuously monitored and an alarm is activated on the master unit when no signal is received from the remote unit for at least a time longer than a preset interval. If the separation distance between the master and remote unit is exceeded for a time longer than a preset time interval, the remote unit activates an alarm attached to the remote unit. The master unit may also be used to activate manually the remote unit's alarm. A pin or key arrangement is provided that ensures that the remote unit is not deactivated without interfacing with the master unit.

Ingargiola et al., U.S. Pat. No. 5,748,087 describes a remote monitoring system, particularly useful in monitoring the position of a child or Alzheimer's patient, having a first unit including a handheld portable transmitter and receiver; and a second unit including two identical sections, wherein each section is carried in one of a footwear pair, and each section has a transmitter and receiver. The transmitter of the first unit has a selective switch for on-demand transmission of a find signal. The transmitters of the second unit each continuously emits a location signal. The receiver of the first or handheld unit is responsive to one of or both location signals. The handheld unit generates an audible alarm indicating that the person wearing the footwear has gone beyond a preset distance from the first or handheld unit. The receivers of the second unit each receive the find signal generated by the first unit, and in response thereto, actuates a plurality of illuminating devices, such as LEDs in the soles of the footwear as well as actuating an audio alarm from the footwear.

Prakash, U.S. Pat. No. 5,841,352 describes a monitor system comprising first and second watches for wear by first and second users of the system. Each watch includes a battery therein for powering a transmitter and receiver. A signal limiter provides a base signal to a comparator so that the comparator can compare the base signal to a transmitted signal from one watch as received by the receiver of the other watch. Upon the received signal being less than the base signal, the comparator closes a relay which in turn energizes an alarm. The alarm indicates that an undesired amount of separation has occurred between the two watches. The strength of the signal produced by the signal limiter can be varied such that the desired degree of separation between the watches, which energizes the alarm, can be varied. A panic button is provided so that an alarm in one watch can be energized by the user of another watch irrespective of the distance between watches. The use of the monitor system in a watch-type configuration allows for its unobtrusive use.

Olmassakian, U.S. Pat. No. 5,900,817 describes a monitoring system for indicating to a supervisory individual, such as an adult, when a monitored individual, such as a child, has moved beyond a safe predefined maximum distance limit. The monitoring system includes a first electronic module suitably fixed to the monitored individual and arranged to exchange signals that are useful to determine the relative distance and direction the first electronic module is from a suitable second electronic module. The second electronic module, which is in the possession of the supervisory individual, is arranged to exchange signal information with the first electronic module and indicate to the supervisory individual information including when the distance between, and the direction of, the monitored individual. Should the distance between the monitored and supervisory individuals increase beyond the maximum distance limit, an alarm situation may be annunciated by an audio annunciator (or other suitable annunciation device). The second electronic module includes a direction display and distance display, that may be employed by the supervisory individual to locate the monitored individual.

Mohr, U.S. Pat. No. 6,127,931 describes a device for monitoring the movement of a person including a homing unit and a base unit. The homing unit includes a device for generating a homing signal and a transmitter for transmitting the homing signal at predetermined intervals. The base unit includes a receiver for receiving the homing signal, a processor for processing the homing signal to determine whether the homing unit is within a predetermined distance from the base unit and generating an alarm signal upon determining the homing unit is at a distance from the base unit greater than the predetermined distance. An alarm is provided on the base unit for alerting a user that the homing unit has moved a distance greater than the predetermined distance from the base unit upon receipt of the alarm signal from the processor. The alarm is at least one of an audible alarm, a visible alarm and a vibratory alarm. At least one of the base unit and homing unit includes a device for adjusting the predetermined distance. The processor determines a time between receipt of sequentially transmitted homing signals to determine the distance between the base unit and homing unit. The base unit further includes a display for displaying the distance between the base unit and homing unit and a direction to the homing unit from the base unit.

Bistar Electronics, Inc., WO 94/12956 describes a portable anti-theft system and method for sounding an alarm which is a speech synthesizer when a first portable unit and a second portable unit become separated by a predetermined distance is disclosed herein. The system comprises transmitter means in the first portable unit for transmitting, a signal, receiver mews in said second portable unit for receiving the signal transmitted by the transmitter means, signal strength determination means in communication with the receiver means for comparing the strength of the received signal with a predetermined signal strength value, logic means for triggering an ahem comprising speech synthesizing means for malting an announcement when the signal strength determination means has determined that the strength of the received signal is less than the predetermined signal strength value.

The prior art teaches an out-of-range personnel monitor and alarm, several different child monitor systems, a remote personal security alarm system, a device for monitoring the movement of a person, and a portable anti-theft device, but does not teach a monitoring system using a pair of timers to assure the reduction of false triggering when the slave unit is near the edge of the allowed separation between the master and slave. The present invention fulfills these needs and provides further related advantages as described in the following summary.

### SUMMARY OF THE INVENTION

The present invention teaches certain benefits in construction and use which give rise to the objectives described below.

The invention is a monitoring system using a portable master unit and at least one portable slave unit similar to that described by Narcisse, U.S. Pat. No. 4,593,273. The master unit provides an electrical circuit including an antenna, an RF signal amplifier, an RF signal tuner, a countdown timer, an attenuator, an adjustable delay timer, an AND gate and an audible alarm. Each of the slave units provide a slave circuit including a transmitter with a transmitting antenna and an RF pulse generating circuit. The master unit is adjusted for receiving a threshold level of RF energy which is transmitted by a slave unit that is within a predetermined distance or separation from the master unit. When the slave unit is too distant for reception of its signal by the master unit, a timer begins a timeout sequence. If the slave unit is not returned within range prior to timeout of the timer, an alarm is set off to alert one of the fact that the slave is outside of reception range. If the slave is returned within range then no alarm is set off. Separation distance of master and slave and the maximum period exceeding the allowable separation distance are both selectable parameters. It is noticed that Narcisse teaches that the base unit (our master unit) send a first signal, and the mobile (our slave unit) responds with a second signal. When no response is received by the base unit an alarm is sounded. PCT improves with a speech synthesis device and teaches the means for determining signal level. Traxler improves over Narcisse with a similar sequence except the mobile unit sounds an alarm rather than the base unit. Traxler teaches that a time delay is appropriate to avoid false triggering. Ingargiola et al teaches a more complex circuit with various alarm devices and footwear enablement. Prakash teaches enablement in a wrist watch type mounting with both units having transmitter and receiver. Olmassakian teaches an improvement including a direction indicator. Mohr still further improves on the prior references by including a homing device enabled for determining the actual distance between units and the direction of one unit from the other. All of the prior art units operate on the basis of signal strength computation and the use of attenuation to select acceptable maximum separation. None of the prior art units teach a dual timing method for reducing the probability of false or unwanted alarms.

A primary objective of the present invention is to provide an apparatus and method of use of such apparatus that provides advantages not taught by the prior art.

Another objective is to provide such an invention capable of setting off an alarm signal when a slave unit is out of radio reception range.

A further objective is to provide such an invention capable of canceling the alarm signal if the slave unit is back within radio reception range prior to a preselected time period.

A still further objective is to provide such an invention capable of preventing false alarms using a dual timer system.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a person, adult at left, carrying a master unit of the invention, a person, child at right, carrying a slave unit of the invention and a crowd of persons in the vicinity of the master and the slave unit, such as might be experienced at an amusement part, a shopping mall, or any similar crowed place, wherein the master unit is within reception distance of the slave unit;

FIG. 2 is a perspective view as shown in FIG. 1, wherein the master unit is not within reception distance of the slave unit; and

FIG. 3 is a block diagram showing the elements of the invention and their interrelationship.

### DETAILED DESCRIPTION OF THE INVENTION

The above described drawing figures illustrate the invention in at least one of its preferred embodiments, which is further defined in detail in the following description.

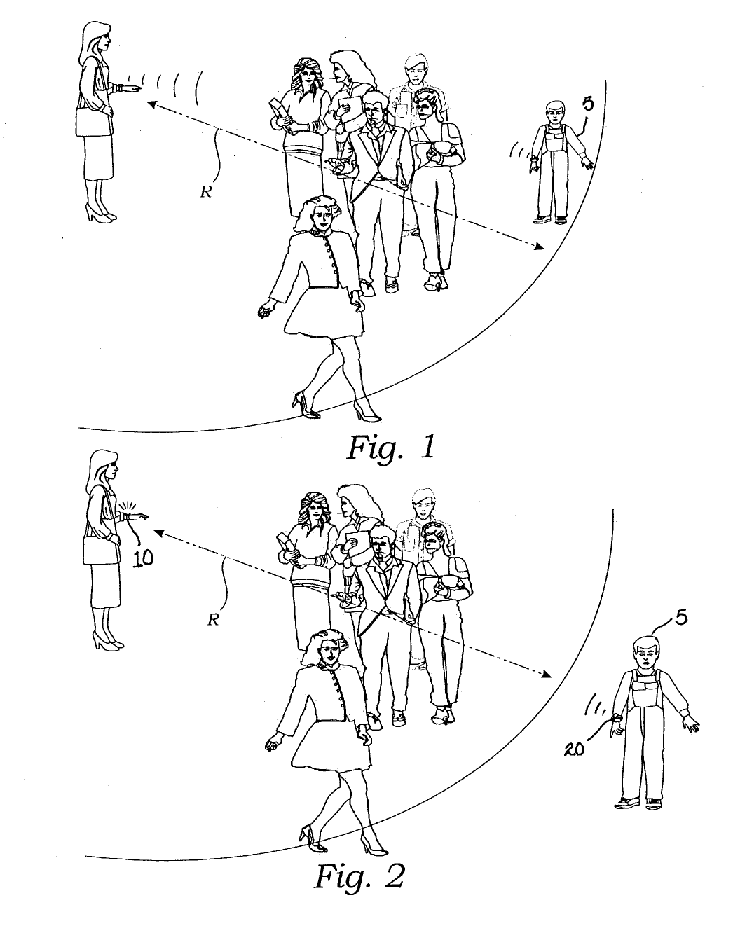

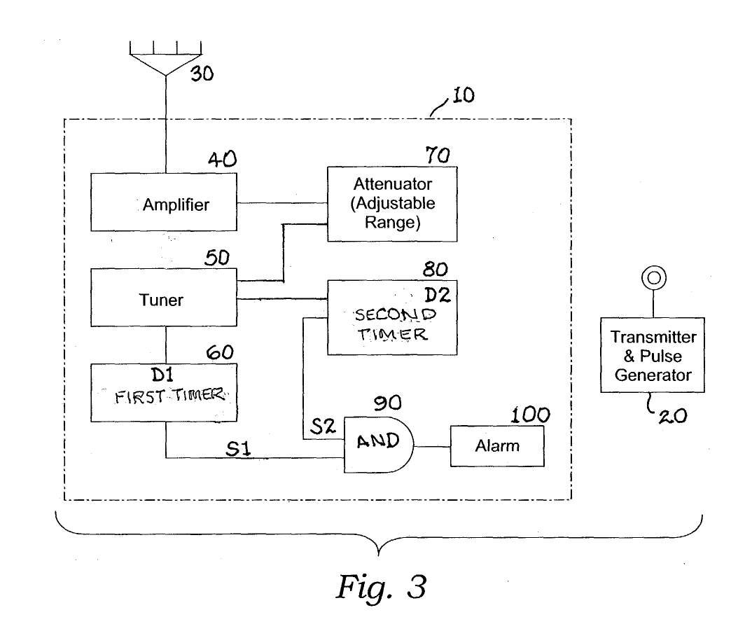

A personnel or article monitoring system uses a miniature portable master unit 10 and at least one portable slave unit 20, the units each constructed and embodied for portability as a hand, belt or wrist mounted device. The master unit 10 provides an electrical circuit including an antenna 30, an RF signal amplifier 40, an RF signal tuner 50, a first timer 60, an attenuator 70, second timer 80, an AND gate 90 and an audible alarm 100. The slave unit 20 provides a slave circuit including a transmitter 22 with transmitting antenna 24 and an RF pulse generating circuit 26. The master unit 10 is adjusted for receiving an RF signal transmitted by the slave unit 20 up to a selected distance parameter “R” as shown in FIGS. 1 and 2. A time delay parameter D1 is set using the first timer 60 so that the slave 20 may be positioned beyond the allowable distance parameter “R” for a pre-selected duration before the alarm is triggered. The master 10 may be adapted to be used with plural slaves 20 by adjusting the tuner 50 for tuning plural independent wavelengths and by applying a switch (not shown) for selecting which frequency is to be used at any one time for monitoring the respective slave unit 20.

The antenna 30 and the RF signal amplifier 40 may advantageously be of the type employed in cell phone circuits and are very well known in the art. The tuner 50 is a simple device constructed to receive a selected single wavelength when only one slave unit 20 is used, and several distinct wavelengths when plural slave units 20 are used, and in that instance the tuner 50 provides for selection of different RF frequencies to monitor the plural slave units 20, each one adapted for transmitting on one of the selected different RF frequencies. In operation, when the signal from the amplifier 40 is no longer above a selected threshold value and thus not received at the countdown timer 60, it triggers the start of a countdown sequence in the second timer 80. The duration of this countdown sequence is preferably adjustable. FIG. 2 shows an instance when the subject 5 is outside the selected range “R” so that the first timer circuit 60 is no longer able to receive the signal transmitted from the slave unit 20 due to a combination of low signal strength arriving at antenna 30 and attenuation at attenuator 70. When that occurs, the first timer 60 starts its countdown of duration D1. At the end of the countdown duration the countdown timer 60 presents a signal S1 to the AND gate 90. Simultaneous with start of the first timer 60 second timer 80 starts its own countdown of duration D2. At the end of D2, timer 80 sends its own signal S2 to AND gate 90. If S1 and S2 are both present simultaneously at AND gate 90, then an alarm signal is sent to alarm 100 and an audible alarm is sounded. Alternatively a vibration or other alarm signals may be employed. Several results are possible. D2 is always triggered along with D1 when the tuner circuit 50 fails to receive an adequate signal strength from attenuator 70. After the period D1, timer 60 sends signal S1 to AND gate 90 and this does not depend upon the state of tuner 60 at that moment. However, timer 80 resets each time a signal is generated at tuner 50, and each time the signal is lost again, the timing duration D2 is re-initiated. At the end of duration D2, signal S2 is sent to AND gate 90. When signal is resumed from tuner 50, timer 80 resets and signal S2 is cancelled. Only when S1 and S2 are both present will gate 90 trigger the alarm signal to alarm 100.

Thus, the master unit 10 is able to establish a provisional alarm period D1 each time signal from slave 20 is lost, assuming D1 is not already in progress. Now, during D1 signal at tuner 50 may be recaptured and lost plural times. D2 may cycle plural times during D1. If D1 terminates at the time D2 is also terminated, then gate 90 is triggered. This process prevents most false triggering when the slave 20 is near the edge of range “R.” Consider, if slave 20 moves beyond “R” for only a moment it may not be desirable to trigger the alarm since slave 20 may move within range in a short time. Also, at position “R” the signal may waver on and off sequentially thereby causing a false triggering. If only a single timer, say first timer 60, were used, the alarm would be sounded after D1 each time the signal were lost. This would not be desirable as it would cause a nuisance alarm. Timer 80 could be used alone but this would cause an alarm to occur each time slave 20 moves beyond “R,” with the alarm stopping each time slave 20 returns within “R.” None of these possibilities are desirable. However, when timers 60 and 80 are used together, it becomes possible to set a longer time D1 to allow the slave 20 to move in the vicinity of “R” without triggering a sequence of alarms, while also assuring that if slave 20 move beyond “R” for the duration D1, the alarm will be sounded. Clearly, some false or unwanted alarming will occur with the present circuit, but tests have shown that the present circuit reduces nuisance alarms to a highly satisfactory level and is highly useful as a low cost solution.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A monitoring apparatus comprising: a master unit and at least one slave unit, each of the units encased and sized for being carried on one of a person and an article; the master unit providing an electrical circuit including an antenna, an RF signal amplifier, an RF signal tuner, a first timer, an attenuator, second timer, an AND gate and an alarm; each of the slave units providing a slave circuit including a transmitter with transmitting antenna and an RF pulse generating circuit; whereby the master unit is adjusted for receiving RF energy transmitted by the slave unit; the alarm enabled for activation when both of the timers complete respective timeout sequences after loss of the RF signal at the RF signal tuner.

2. A monitoring method comprising the steps of: providing a master unit carried by a person; providing a slave unit carried by one of a person, an animal and an article; generating an RF signal at the slave unit; receiving the RF signal at the master unit when the master and slave units are separated by a distance less than “R”; starting a first timing duration when the master and slave units are separated by a distance greater than “R” and producing a first timer signal when the first timing duration is completed; starting a second timing duration when the master and slave units are separated by a distance greater than “R” and producing a second timer signal when the second timing duration is completed; interrupting the second timing duration when the master and slave units are again separated by a distance less than “R” and the second timing duration has not been exceeded; and producing an alarm action when the first and the second timer signals are present simultaneously.

3. The method of claim 2 further comprising the step of providing an RF signal amplifier for amplification of the slave unit RF signal within the master unit.

4. The method of claim 3 further comprising the step of providing an RF signal tuner for discriminating the slave unit RF signal from background noise and for selecting a target wavelength from a plurality of wavelengths.

5. The method of claim 4 further comprising the step of providing an attenuator for selecting a target separation distance between the master and the slave units.

6. The method of claim 5 further comprising the step of providing an AND gate connected enabled for activating an alarm upon receiving the first and the second timing signals simultaneously.

7. The method of claim 6 further comprising the step of providing an RF pulse generating circuit in the slave unit enabled for generating the slave RF signal.

8. The method of claim 7 further comprising the step of adjusting the target unit separation, and first and second timing durations.
